(19) United States
(12) Patent Application Publication
(10) Pub. No.: US 2026/0056032 A1
(43) Pub. Date: Feb. 26, 2026

(54) CROP SENSOR WANDS AND RELATED DEVICES SYSTEMS AND METHODS

(71) Applicant: Ag Leader Technology, Ames, IA (US)

(72) Inventors: Lucas Roe, Ames, IA (US); Parker Wells, Polk City, IA (US); Mel Zayas, Orlando, FL (US); Jacob Werner, Ames, IA (US); Brett Johnson, Ames, IA (US)

(21) Appl. No.: 19/305,530

(22) Filed: Aug. 20, 2025

Related U.S. Application Data
(60) Provisional application No. 63/685,000, filed on Aug. 20, 2024.

(51) Int. Cl. G01D 5/14; A01D 45/02

(52) U.S. Cl. CPC G01D 5/14; A01D 45/023

(57) ABSTRACT

A stalk sensing system, comprising a bracket, sensor shell configured to be mounted to the bracket, a sensor configured for insertion into the sensor shell, a wand configured to be mounted to the sensor shell, and one or more anti-rotation features. The harvester and stalk sensing system may also into one or more board holding features and, optionally, a crop divertor(s).

### CROSS-REFERENCE TO RELATED APPLICATION(S)

This application claims the benefit under 35 U.S. C. § 119(e) to U.S. Provisional Application 63/685,000, filed Aug. 20, 2024, and entitled CROP SENSOR WANDS AND RELATED DEVICES SYSTEMS AND METHODS, which is hereby incorporated herein by reference in its entirety for all purposes.

### TECHNICAL FIELD

The disclosure relates to agricultural harvesters and associated sensors, systems, and devices.

### BACKGROUND

Various sensors for measuring and counting stalks and collecting certain data relating to harvest and planting are known in the art. Various sensors are disclosed in U.S. application Ser. No. 16/445,161, U.S. application Ser. No. 16/800,469, U.S. application Ser. No. 17/013,037, and U.S. application Ser. No. 17/226,002, each of which has been incorporated by reference herein.

### BRIEF SUMMARY

In Example 1, a stalk sensing system, comprising a bracket, a sensor shell configured to be mounted to the bracket, a sensor configured for insertion into the sensor shell, a wand configured to be mounted to the sensor shell, and one or more anti-rotation features.
Example 2 relates to the stalk sensing system of any of Examples 1 and 3-8, wherein the one or more anti-rotation features include one or more of sensor shell walls, a bracket anti-rotation boss, a wand anti-rotation boss, and a compression limiter.
Example 3 relates to the stalk sensing system of any of Examples 1-2 and 4-8, wherein the one or more anti-rotation features is a bracket anti-rotation boss extending from the sensor shell and configured to mate with a corresponding opening in the bracket.
Example 4 relates to the stalk sensing system of any of Examples 1-3 and 5-8, wherein the one or more anti-rotation features is a wand anti-rotation boss extending from the sensor shell and configured to mate with a corresponding depression in the wand.
Example 5 relates to the stalk sensing system of any of Examples 1-4 and 6-8, wherein the one or more anti-rotation features is a compression limiter in a bolt opening of the sensor shell.
Example 6 relates to the stalk sensing system of any of Examples 1-5 and 7-8, further comprising a crop divertor configured to be mounted to a harvester row unit and configured to direct crops to a center of the row unit between gathering chains.
Example 7 relates to the stalk sensing system of any of Examples 1-6 and 8, wherein the sensor shell comprises one or more boarding holding features configured for proper placement and retention of a board of the sensor.
Example 8 relates to the stalk sensing system of any of Examples 1-7, wherein the one or more board holding features include one or more of board holding rails, sensor wire divots, sensor wire ribs, board holding ribs, and a potting feature.
In Example 9, a corn header comprising a plurality of row units, each row unit comprising a set of gathering chains, and a crop divertor extending from a body of the row unit over a gathering chain sprocket, the crop divertor comprising an angled body with an outer surface configured to contact crops when the row unit is misaligned and urge the crops toward a center of the row unit.
In Example 10, a stalk sensor assembly comprising a wand, a sensor shell configured to mate with the wand, and a bracket configured to mate with the sensor shell wherein the stalk sensor assembly comprise one or more anti-rotation features.
Example 11 relates to the stalk sensor assembly of any of Examples 10 and 12-20, wherein the one or more anti-rotation features is a bracket anti-rotation boss extending from the sensor shell and configured to mate with a corresponding opening in the bracket.
Example 12 relates to the stalk sensor assembly of any of Examples 10-11 and 13-20, wherein the one or more anti-rotation features is a wand anti-rotation boss extending from the sensor shell and configured to mate with a corresponding depression in the wand.
Example 13 relates to the stalk sensor assembly of any of Examples 10-12 and 14-20, wherein the one or more anti-rotation features comprise one or more walls along one or more edges of the sensor shell configured to mate with corresponding depressions in the wand.
Example 14 relates to the stalk sensor assembly of any of Examples 10-13 and 15-20, wherein the one or more anti-rotation features is a compression limiter in a bolt opening of the sensor shell.
Example 15 relates to the stalk sensor assembly of any of Examples 10-14 and 16-20, further comprising one or more sensor board holding features on the sensor shell.
Example 16 relates to the stalk sensor assembly of any of Examples 10-15 and 17-20, wherein the one or more sensor board holding features is at least two board holding rails configured to hold a sensor board in place by compression or friction.
Example 17 relates to the stalk sensor assembly of any of Examples 10-16 and 18-20, wherein the sensor board comprises a keep out zone along one or more edges wherein the sensor board is configured to abut the at least tow board holding rails.
Example 18 relates to the stalk sensor assembly of any of Examples 10-17 and 19-20, wherein the one or more sensor board holding features is a board holding ribs wherein an edge of a sensor board is configured to rest against the board holding rib.
Example 19 relates to the stalk sensor assembly of any of Examples 10-18 and 20, further comprising a potting flow feature.
Example 20 relates to the stalk sensor assembly of any of Examples 10-19, further comprising a routing rib and a divot, wherein a wire extending from a sensor board is routed through the divot and adjacent to the routing rib.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a top view of a row unit centered on a crop row, according to one implementation.

FIG. 2 is a top view of a row unit misaligned with a crop row, according to one implementation.

FIG. 3 is a top view of a row unit having crop divertors redirecting crop to the center of the row unit when misaligned, according to one implementation.

FIG. 4 is a perspective view of a row unit having wear strips, according to one implementation.

FIG. 5 is a perspective view of a row unit having wear strips and crop divertors, according to one implementation.

FIG. 6 is a perspective view of a row unit having wear strips and crop divertors, according to one implementation.

FIG. 7 is a side view of a stalking sensing system wand mount, according to one implementation.

FIG. 8 is a top view of a stalk sensing system wand mount, according to one implementation.

FIG. 9 is a bottom view of a stalk sensing system wand mount, according to one implementation.

FIG. 10 is a bottom view of a stalking sensing system wand mount on a bracket, according to one implementation.

FIG. 11 is a perspective view of a stalk sensing system bracket, according to one implementation.

FIG. 12 is a perspective view of a stalk sensing system wand, according to one implementation.

FIG. 13 is a bottom view of stalk sensing system mount having a seated board, according to one implementation.

FIG. 14 is a bottom view of stalk sensing system mount sensor cavity, according to one implementation.

FIG. 15 is a bottom view of stalk sensing system mount sensor cavity, according to one implementation.

FIG. 16 is a bottom view of a stalk sensing system board mounted in the sensor cavity, according to one implementation.

FIG. 17 is a schematic view of a stalk sensing system board, according to one implementation.

### DESCRIPTION

Disclosed herein are various devices, systems, and methods for use in connection with agricultural harvester, including but not limited to combine harvesters and corn headers. The various devices disclosed herein include a crop divertor configured to urge stalks toward the center of the row unit prior to entering the gathering chains without bunching or gathering at the front of the gathering chains (near the sprocket). Additionally disclosed herein are various anti-rotation devices configured to be used in connection with sensor wands to prevent undesired rotation of the wands during operation. Further disclosed is a sensor mounting configured to hold a sensor board in place within the mounting securely and in a repeatable manner.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sept. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. Patent Application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sept. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. Patent Application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices, and Methods,” U.S. Patent Application 63/710,492, filed Oct. 22, 2024, entitled “Crop Sensors and Related Devices, Systems, and Methods,” U.S. Patent Application 63/710,641, filed Oct. 23, 2024, entitled “Agricultural Sprayer Boom Flush, Chemical Detection and Chemical Concentration Detection,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,”each of which is incorporated herein by reference.

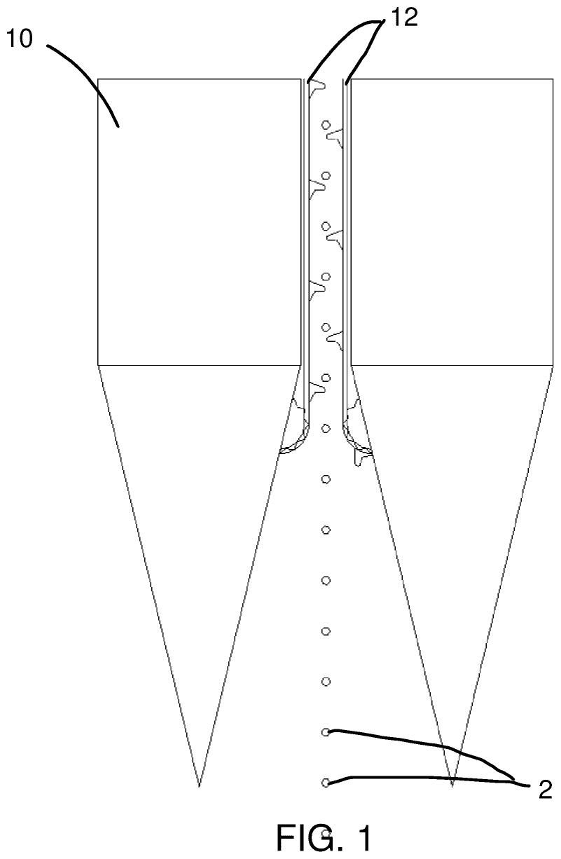

Turning now to the figures in further detail FIGS. 1-6 show and describe the use of a crop divertor 20 for configured to urge stalks 2 toward the center of the row unit 10 prior to entering the gathering chains 12 without bunching or gathering at the front of the gathering chains 12 (near the sprocket 12A).

FIG. 1 shows an exemplary row unit 10 with exposed gathering chains 12 during operation centered/aligned with a row of crop 2. As can be seen, when the row unit 10 is centered/aligned with the crop 2, crop singulation is maintained. That is, stalks 2 enter the row unit 10 one at a time. Singulation in this manner is important for optimizing harvest and yield, as would be generally understood.

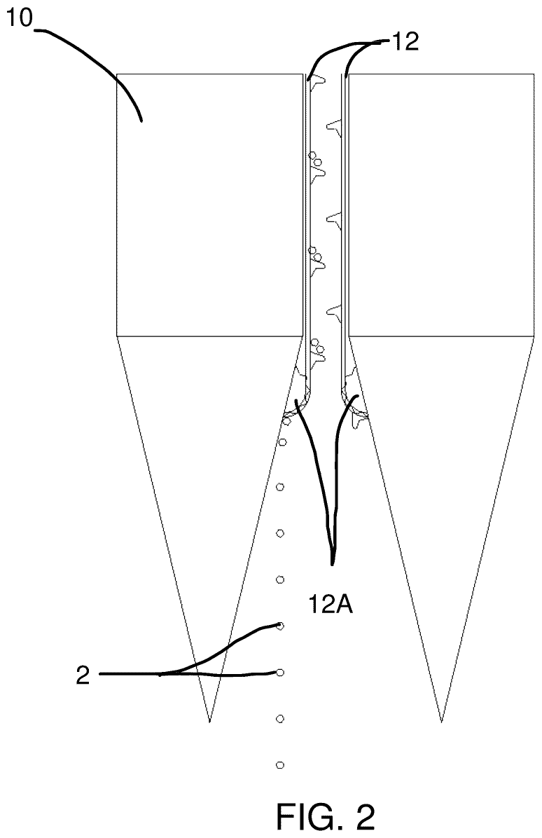

FIG. 2 shows a row unit 10 with exposed gathering chains 12 during operation, where the row unit 10 is misaligned with the crop 2 such that crops 2 engage with the front of the gathering chains 12 (sprocket 12A) instead of entering the row unit 10 in the space between the gathering chains 12. Here, crop singulation is interrupted making the row unit 10 less effective, prone to bunching, and causing stalk counting systems to have difficulty distinguishing between individual stalks (that is, counting only one stalk when there was two or more).

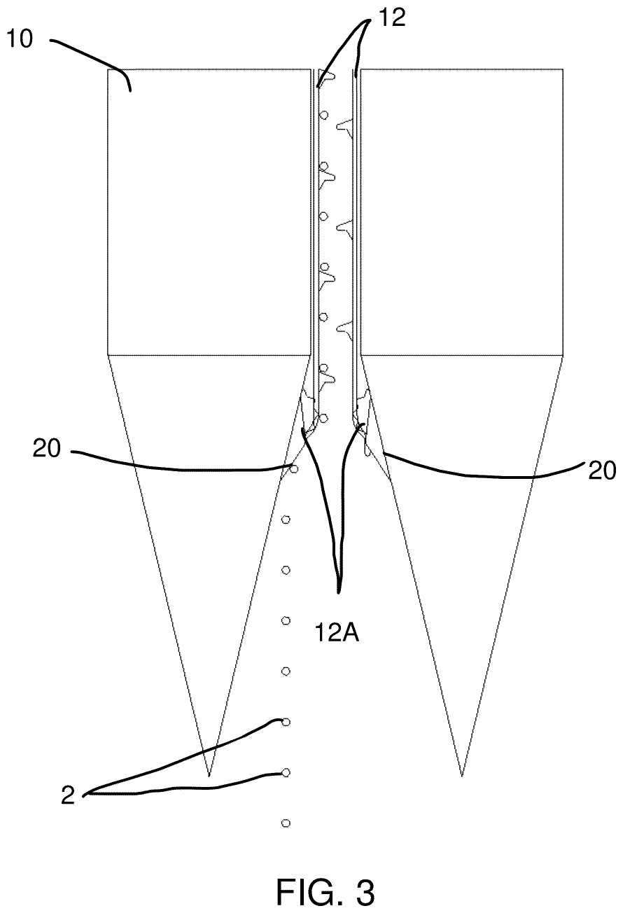

Shown for example in FIG. 3, In various implementations, an agricultural harvester (e.g., a combine) may include a rigid part 20 (also referred to herein as a “crop divertor 20”) on the corn head snout or crop divider to improve crop 2 flow and guide stalks around an exposed gathering chains 12. That is, the crop divertor 20 urges stalks 2 towards the center of the row unit 10 into the space between the gathering chains rather than allowing bunching. The crop divertor 20 provides a surface to redirect crops 2 to the center of the row unit 10 prior to the gathering chains 12 to maintain the singulation of the plants along the row unit 10, as well as their relative position to the ground.

As can be seen, the crop divertor 20 includes an angled body extending from the body of the row unit 10/crop divider 16. The divertor 20 extending sufficiently toward the center of the row unit 10 opening such that when crops slide along the surface of the crop divertor 20, the crops do not gather at the front of the gathering chain 12 sprocket 12A, but instead are diverted into the center of row unit 10 opening to be gathered by the flutes 12B of the gathering chains 12. Optionally the crops are prevented from bunching, are singulated prior to encountering sensors (e.g. wands) of a stalk counting/sensing system 30. In various implementations, the crop divertors 20 are integral to the row unit 10. In certain implementations, the crop divertors 20 are retrofitted to an existing row unit 10. In some implementations, the crop divertors 20 are replaceable.

In FIG. 3 the row unit 10 is misaligned with the crop 2 row such that during operation the crop 2 follows the surface of the crop divertor 20 into the center of the row unit 10 rather than bunching at the front of the gathering chains 12 near the sprocket 12A. As can be seen, plant singulation is maintained allowing for efficient separation of crop 2, no or minimal bunching, and increased ability for stalk 2 counting systems to distinguish individual stalks 2.

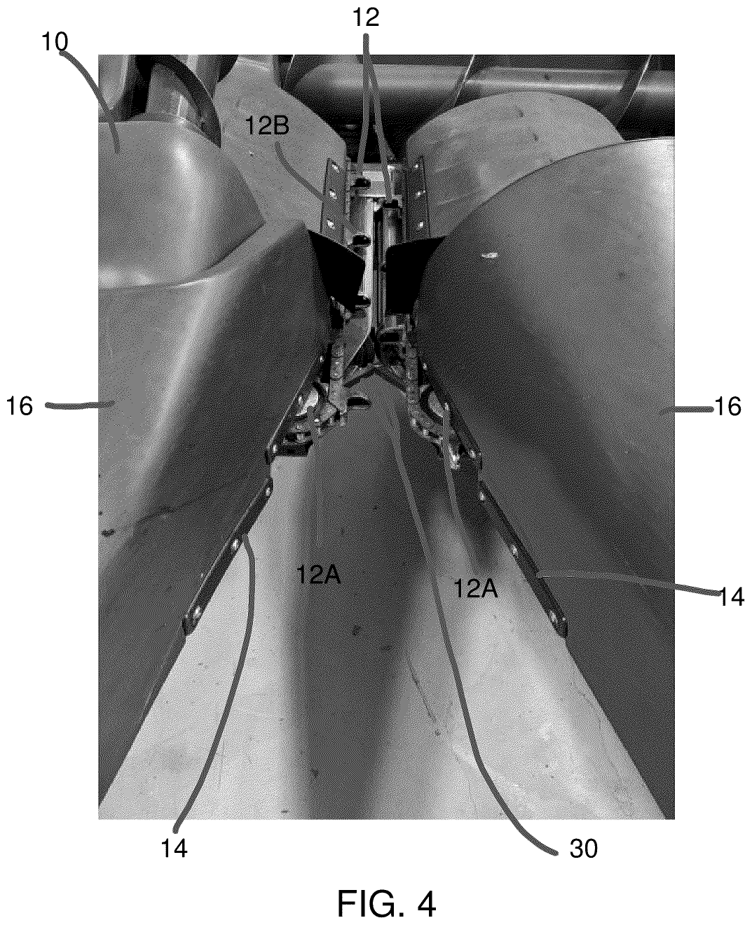

FIG. 4 shows an exemplary row unit 10 including wear strips 14 where a misaligned crop row may impact the crop divider 16 to prevent wear to the body of the row unit 10. Additionally, certain row units 10 may include a stalk counting system 30, such as that from Ag Leader® and would be recognized by those of skill in the art, and are described in further detail in certain of the incorporated references.

These known wear strips 14 do not direct the stalk around the end of the gathering chains 12, but instead merely provide a surface to protect the body of the crop divider 16 from damage due to repeated friction from misaligned stalks. When the harvester is sufficiently misaligned with the row, such that stalks will slide down the snout 16, they tend to get caught on the front face of the gathering chains 12 impeding the flow of the stalks into the corn head (shown for example in FIG. 2), as would be understood. This creates bunching until the next gathering chain 12 flute 12B comes around. Instead, known wear strips 14 are simply flat surfaces abutting the sides of the crop dividers 16 to prevent excess wear on the body of the crop divider 16.

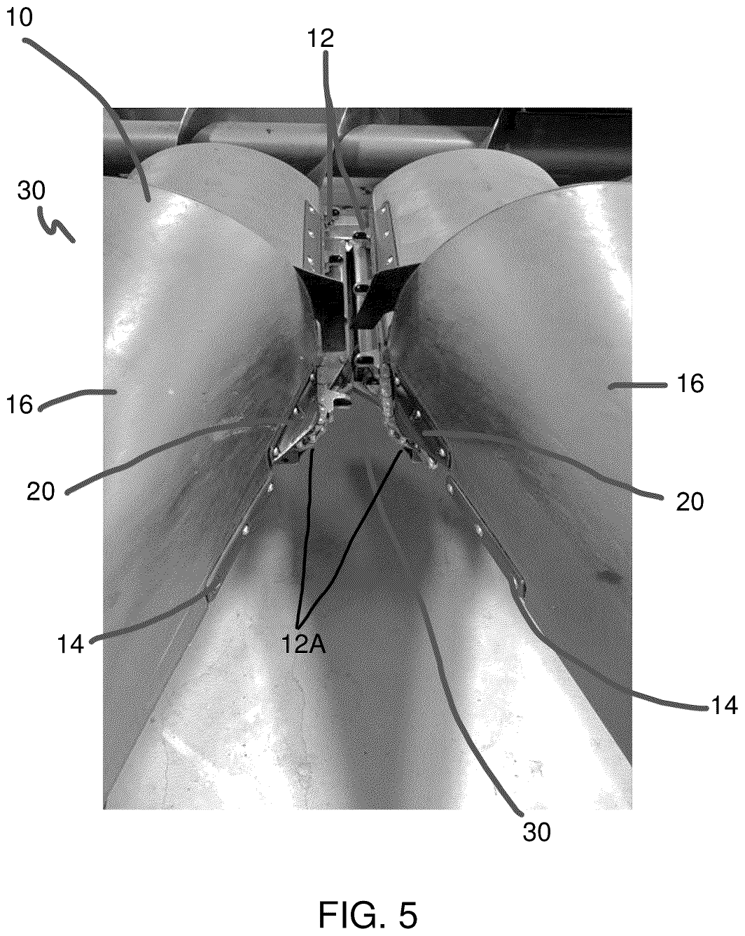

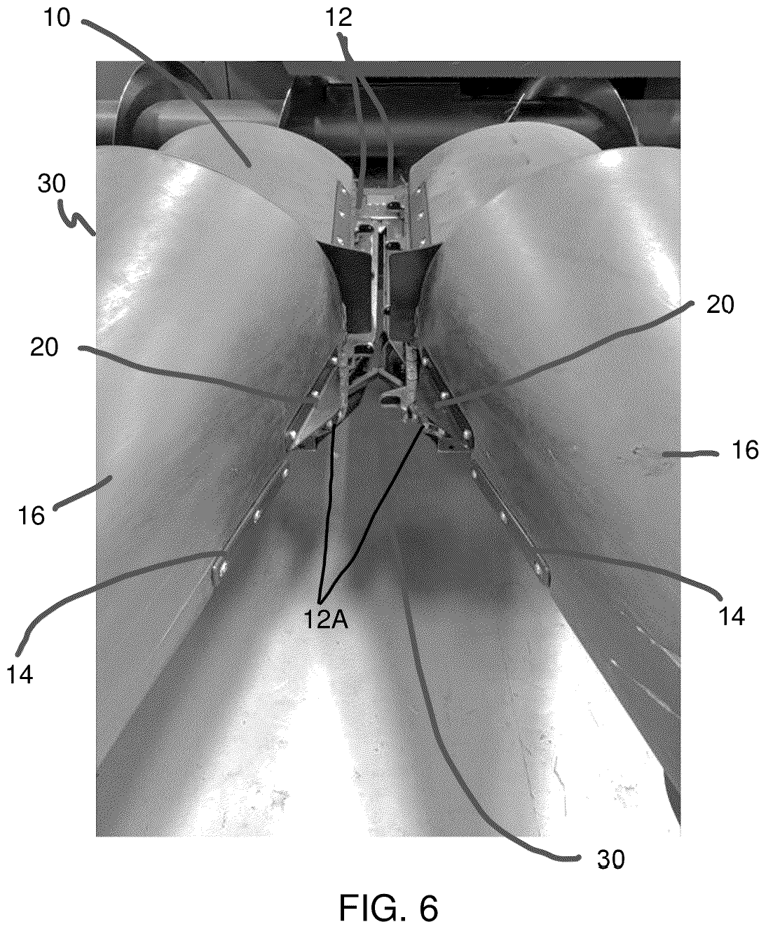

FIGS. 5 and 6 show an exemplary row unit 10 with crop divertors 20 installed above the gathering chain 12 sprockets 12A. The crop divertors 20 may be made from a solid polymer (FIG. 5), sheet metal (FIG. 6), or any other appropriate material or material as would be understood and appreciated by those of skill in the art. The row unit 10 may also include a stalk counting system 30 and/or wear strips 14, as would be understood.

By including one or more crop divertors 20 on a row unit 10 crop flow and singulation of plants into the row unit 10 is improved. Singulation of plants into the row unit 10 allows for population counting systems 30 to be more accurate. By improving the accuracy of the population counting system 30 stakeholders/operators are reliably able to quantify plant stands.

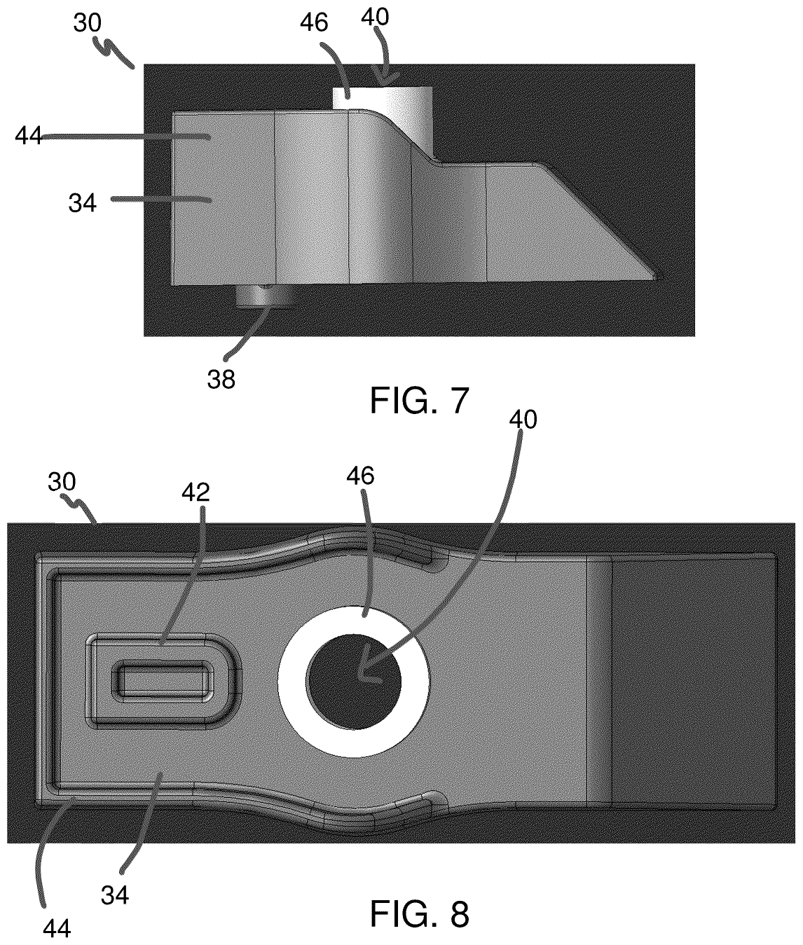

Turning now to FIGS. 7-12, in various implementations, a harvester may include a stalk sensing/counting system 30 which may in tern include one or more wands 32 or mechanical sensing members 32, as has been previously described. In certain of these systems 30 the wands/mechanical sensing members 32 should only rotate to a certain degree to ensure signal quality.

In various implementations, the wands 32 are mounted to a row unit via a single point fastener system consisting of a mount 34 (also referred to as sensor shell 34), a bracket 36, a bolt (not shown), a nut (optionally a PEM nut) (not shown), and one or more anti-rotation features. The anti-rotation features may be on the wand 32, sensor shell 34, and/or bracket 36, as would be understood in light of this disclosure.

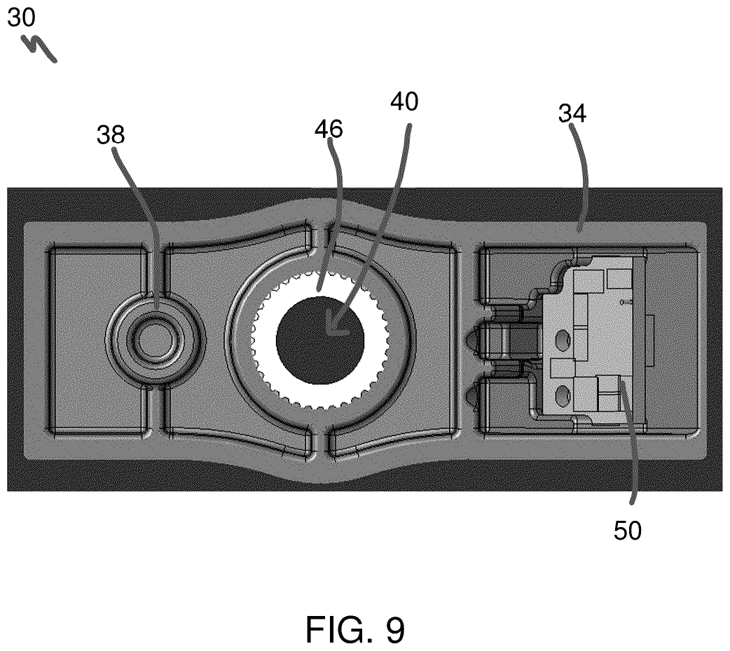

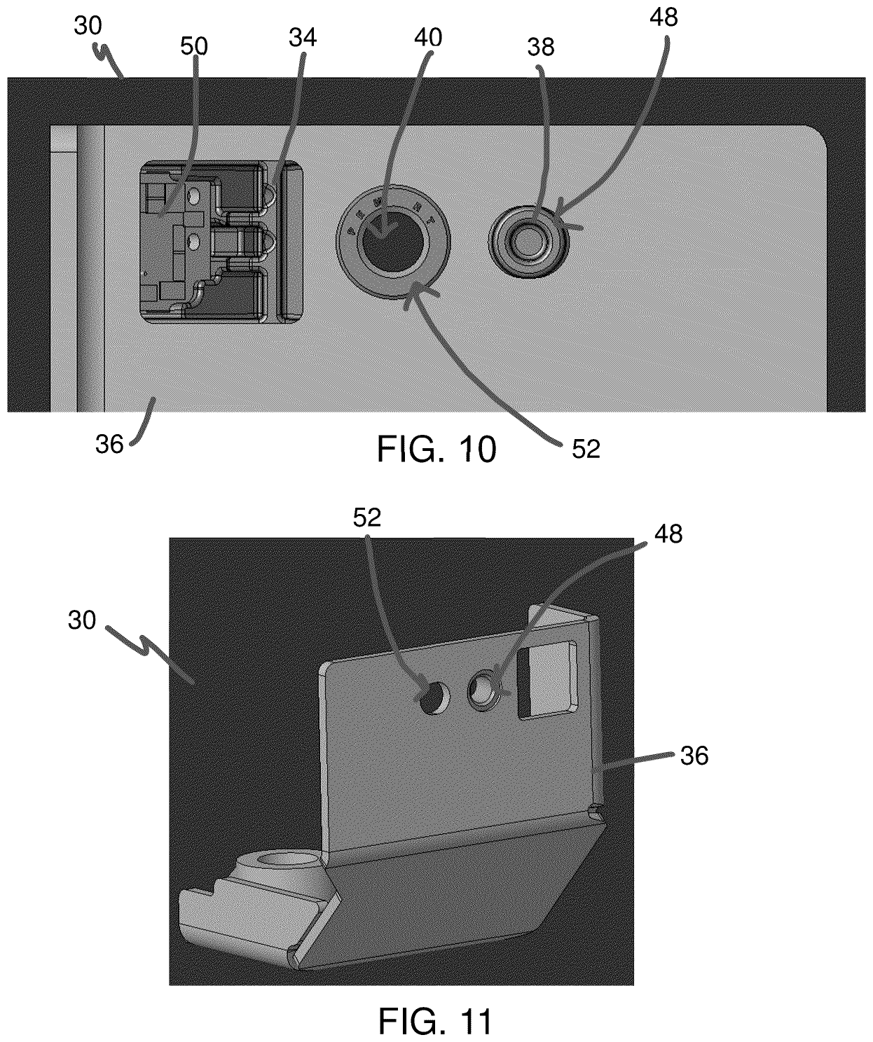

Shown in FIG. 7, an exemplary anti-rotation feature includes a bracket anti-rotation boss 38 and a bolt opening 40 configured to mate to a bracket 36 (shown in FIG. 10). Another optional anti-rotation feature includes a wand anti-rotation boss 42, opposite the bracket anti-rotation boss 38 on the sensor shell 34, shown in FIG. 8. Also shown in FIG. 8 are walls 44/protrusions 44 configured to prevent rotation of the wand 32 relative to the sensor shell 34. A still further anti-rotation feature includes a compression limiter 46 within the bolt opening 40 to mate to a wand 32, shown for example in FIG. 9.

As can be seen in FIGS. 7-9 more than one anti-rotation feature may be present on the sensor shell 34. That is, the sensor shell 34 may include the bracket anti-rotation boss, a wand anti-rotation boss, and/or a compression limiter.

As can be seen in FIGS. 10 and 11, in various implementations, the bracket anti-rotation boss 38 fits into a corresponding opening 48 within the bracket 36. A bolt may also be placed through the bolt opening 40 of the sensor shell 34 and corresponding opening 50 within the bracket 36, secured with a nut, as would be generally understood. In combination, the bolt and nut hold the wand 32 and sensor shell 34 to the bracket 36 while the bracket anti-rotation boss 38 extending through the opening 48 prevents rotation of the sensor shell 34 relative to the bracket.

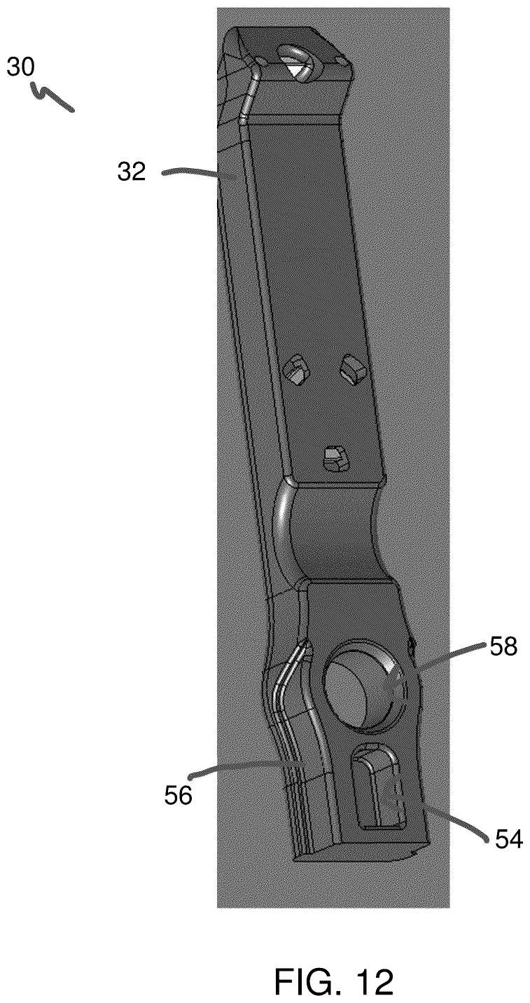

In various implementations, the wand anti-rotation boss 42 is configured to fit within a recess 54 in the wand 32, shown best in FIG. 12. The bolt and nut may extend through the opening 58 in the wand and through the sensor shell 34 and bracket, as has been described, the wand anti-rotation boss extending/mating to the recess 54 to prevent rotation of the wand relative to the sensor shell 34.

In certain implementation, walls 44/protrusions may extend from the sensor shell 34, optionally about the wand anti-rotation boss 38. In various implementations, the walls 44 include raised surfaces on one, two, or three edges of the sensor shell 34, optionally partially surrounding the wand anti-rotation boss. In certain implementations, the walls 44 are unitary/integral with the sensor shell 34. In these and other implementations, corresponding depressions 56 along the wand 32 are configured to accept the walls 44 of the sensor shell 34. The mating of the depression 56 of the wand and the walls 44 of the sensor shell 34 configured to prevent rotation of the wand relative to the sensor shell 34.

A still further anti-rotation feature includes a compression limiter 46 within the bolt opening 40 to mate to a wand 32 via an opening 58 having a negative tolerance. The compression limiter 46 configured to provide joint integrity and prevent undesirable rotation between the components of the sensor system 30.

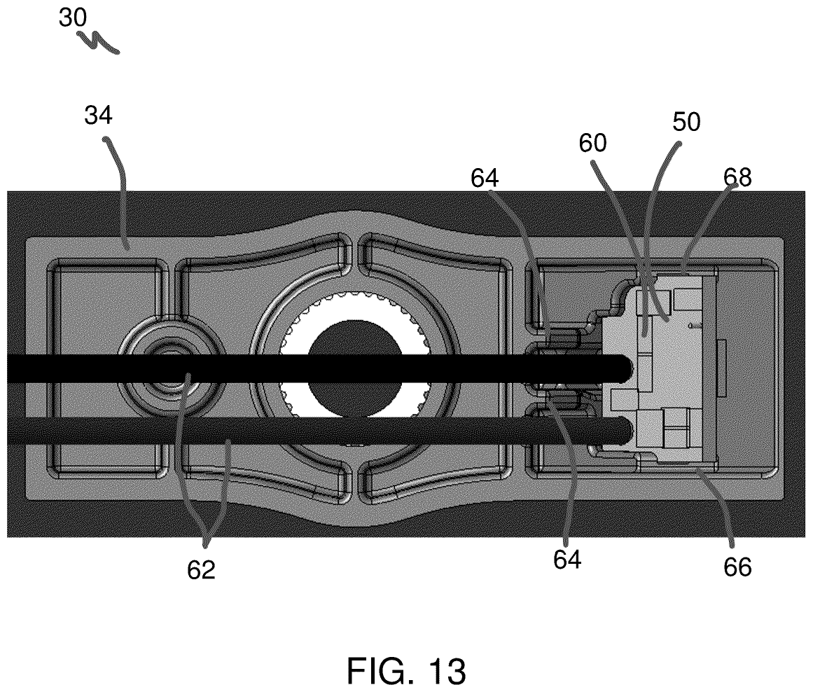

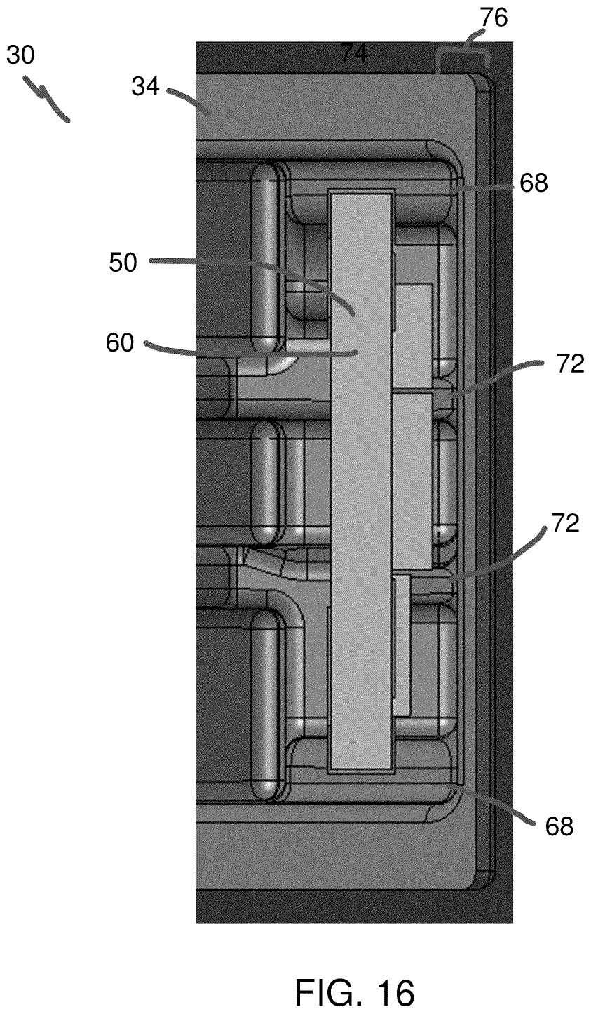

Turning now to FIGS. 13-17, various implementations of the stalk counting/sensing system 30 on the harvester includes one or more board holding features to ensure that the placement of the sensor relative to the sensed object is consistent between the various wands 32 and sensor shells 34 of the system 30. As would be understood, a sensing system 30 may include one or two wands 32 per row unit 10 on a given harvester, and the harvester may include six, twelve, or other number of row units 10. In one example, the board holding features are configured to maintain consistent spacing for the magnetometers on the various wands. Additionally, the board holding feature are configured to hold the board in place during potting.

In various implementations, the board 60 is potted into the sensor shell 34, and held in place by one or more board holding features, as will be described further below. The small nature of the board 60 (printed circuit board (“PCB”) 60) may make the board 60 prone to undesirable movement. The various board holding features are shaped and arranged to prevent this movement. Further, the board holding features ensure that a magnetometer, or other similar sensor, are properly located for sensing a magnet within the wand 32 or the like.

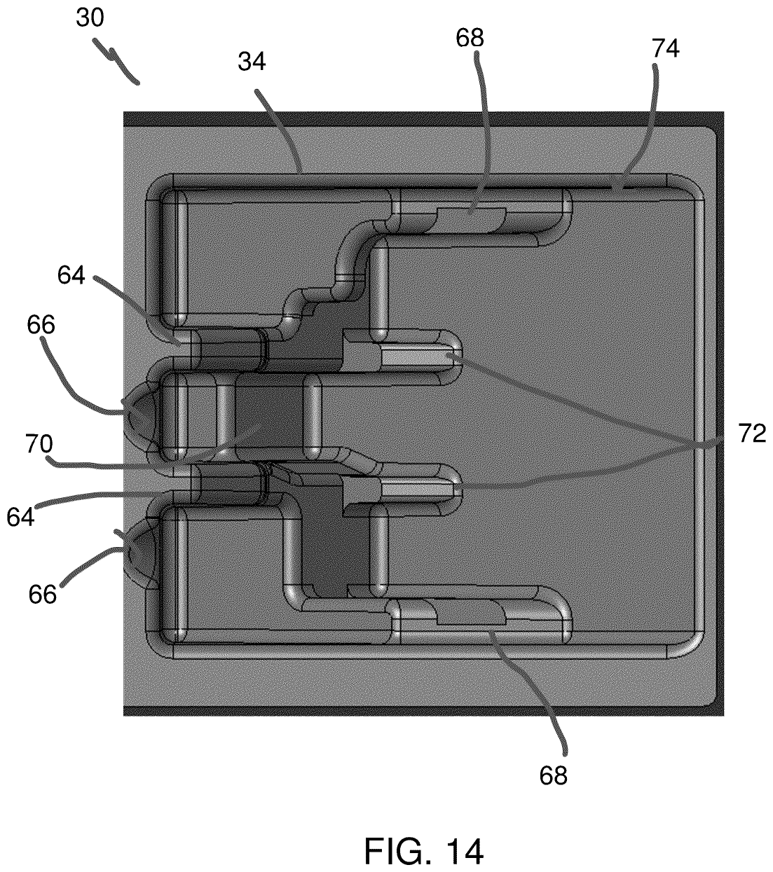

In various implementations, the sensor shell 34 includes sensor wire routing ribs 64 and divots 66 for fitting sensor wires 62 extending from the sensor 50 board 60, shown for example in FIG. 14. Here, wires extending from the sensor 50 board 60 are routed through divots 66 and between the ribs 64.

In these and other implementations, the sensor shell 34 may also include one or more board holding rails 68, shown in FIGS. 14-16. Various implementations include two board holding rails 68 configured for fitting the board 60 between the two rails 68. As would be understood, the board 60 may be held in place via friction or compression by snapping the board 60 into place between the rails 68.

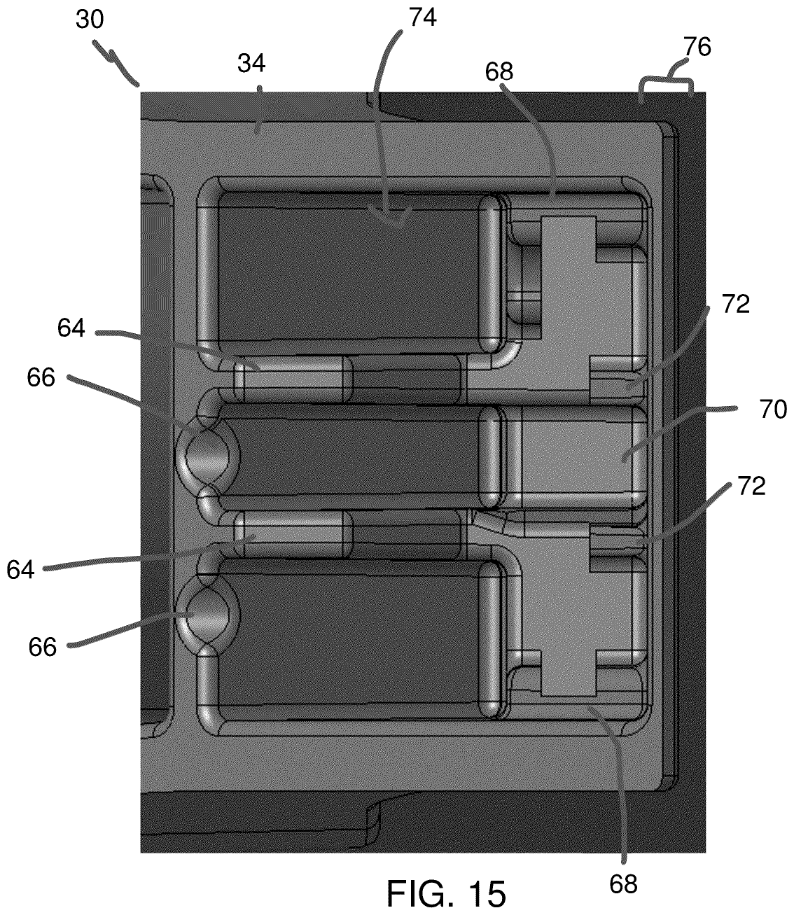

The sensor shell 34 may also optionally include one or more board holding ribs 72. As can be seen in FIGS. 14 and 15, the board holding ribs 72 may be located between the board holding rails 68, such that the surface of the board 60 rests against the ribs 72 when the board is in place. The ribs 72 may provide support to the board 60, as would be understood.

Further, the sensor shell 34 may include a potting flow feature 70 to ensure potting fills the sensor cavity 74. The potting flow feature 70 may be ramped surface to guide the sensor 50 board 60 into place within the shell 34.

In these and other implementations, the sensor shell 34 may also include a perimeter wall 76 defining the sensor cavity 74, shown for example in FIGS. 14 and 15. In various implementations, the perimeter wall 76 is about 1 mm in thickness, although other thicknesses are possible, to achieve proper positioning of the sensor 50 relative to the sensed object (e.g. a magnet in implementations where the sensor 50 is a magnetometer).

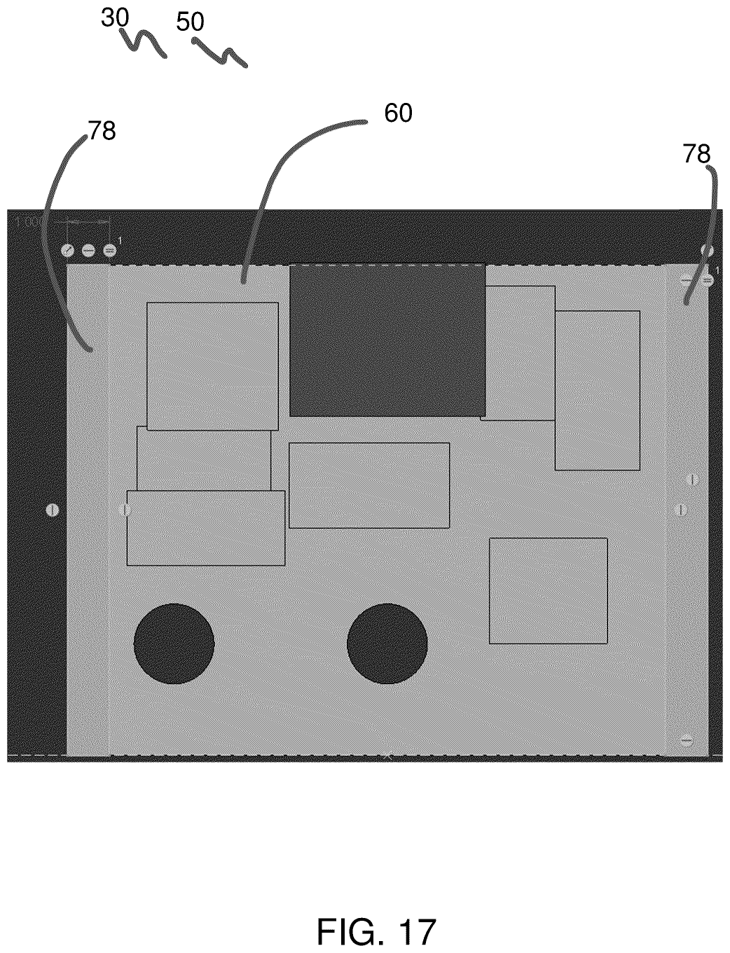

Turning to FIG. 17, in certain implementations, the board 60 includes a keep out zone 78, optionally about 1 mm, on the edges of the board 60 to allow the board 60 to slide into the rails 68 of the shell 34. That is a portion of the edge of the board 60 is left empty such that the board is not damaged or otherwise interfered with when in place and in contacted with the rails 68 and other board holding features discussed herein.

Although the disclosure has been described with references to various embodiments, persons skilled in the art will recognize that changes may be made in form and detail without departing from the spirit and scope of this disclosure.

What is claimed is:

1. A stalk sensing system, comprising:
(a) a bracket;
(b) a sensor shell configured to be mounted to the bracket;
(c) a sensor configured for insertion into the sensor shell;
(d) a wand configured to be mounted to the sensor shell; and
(e) one or more anti-rotation features.

2. The stalk sensing system of claim 1, wherein the one or more anti-rotation features include one or more of sensor shell walls, a bracket anti-rotation boss, a wand anti-rotation boss, and a compression limiter.

3. The stalk sensing system of claim 1, wherein the one or more anti-rotation features is a bracket anti-rotation boss extending from the sensor shell and configured to mate with a corresponding opening in the bracket.

4. The stalk sensing system of claim 1, wherein the one or more anti-rotation features is a wand anti-rotation boss extending from the sensor shell and configured to mate with a corresponding depression in the wand.

5. The stalk sensing system of claim 1, wherein the one or more anti-rotation features is a compression limiter in a bolt opening of the sensor shell.

6. The stalk sensing system of claim 1, further comprising a crop divertor configured to be mounted to a harvester row unit and configured to direct crops to a center of the row unit between gathering chains.

7. The stalk sensing system of claim 1, wherein the sensor shell comprises one or more boarding holding features configured for proper placement and retention of a board of the sensor.

8. The stalk sensing system of claim 7, wherein the one or more board holding features include one or more of board holding rails, sensor wire divots, sensor wire ribs, board holding ribs, and a potting feature.

9. A corn header comprising a plurality of row units, each row unit comprising a set of gathering chains, and a crop divertor extending from a body of the row unit over a gathering chain sprocket, the crop divertor comprising an angled body with an outer surface configured to contact crops when the row unit is misaligned and urge the crops toward a center of the row unit.

10. A stalk sensor assembly comprising:
(a) a wand;
(b) a sensor shell configured to mate with the wand; and
(c) a bracket configured to mate with the sensor shell,
wherein the stalk sensor assembly comprise one or more anti-rotation features.

11. The stalk sensor assembly of claim 10, wherein the one or more anti-rotation features is a bracket anti-rotation boss extending from the sensor shell and configured to mate with a corresponding opening in the bracket.

12. The stalk sensor assembly of claim 10, wherein the one or more anti-rotation features is a wand anti-rotation boss extending from the sensor shell and configured to mate with a corresponding depression in the wand.

13. The stalk sensor assembly of claim 10, wherein the one or more anti-rotation features comprise one or more walls along one or more edges of the sensor shell configured to mate with corresponding depressions in the wand.

14. The stalk sensor assembly of claim 10, wherein the one or more anti-rotation features is a compression limiter in a bolt opening of the sensor shell.

15. The stalk sensor assembly of claim 10, further comprising one or more sensor board holding features on the sensor shell.

16. The stalk sensor assembly of claim 15, wherein the one or more sensor board holding features is at least two board holding rails configured to hold a sensor board in place by compression or friction.

17. The stalk sensor assembly of claim 16, wherein the sensor board comprises a keep out zone along one or more edges wherein the sensor board is configured to abut the at least tow board holding rails.

18. The stalk sensor assembly of claim 15, wherein the one or more sensor board holding features is a board holding ribs wherein an edge of a sensor board is configured to rest against the board holding rib.

19. The stalk sensor assembly of claim 15, further comprising a potting flow feature.

20. The stalk sensor assembly of claim 15, further comprising a routing rib and a divot, wherein a wire extending from a sensor board is routed through the divot and adjacent to the routing rib.
